(19) United States
(12) Patent Application Publication
(10) Pub. No.: US 2023/0266913 A1
(43) Pub. Date: Aug. 24, 2023

(54) MEMORY DEVICE AND OPERATION METHOD PERFORMED BY THE SAME

(71) Applicant: SAMSUNG ELECTRONICS CO., LTD., Suwon-si (KR)

(72) Inventors: Changin CHOI, Suwon-si (KR); Seungwon LEE, Hwaseong-si (KR)

(73) Assignee: SAMSUNG ELECTRONICS CO., LTD., Suwon-si (KR)

(21) Appl. No.: 17/865,824

(22) Filed: Jul. 15, 2022

(30) Foreign Application Priority Data
Feb. 22, 2022 (KR) 10-2022-0023219

(51) Int. Cl. G06F 3/06

(52) U.S. Cl. CPC G06F 3/0655; G06F 3/0604; G06F 3/0679

(57) ABSTRACT

A memory device and an operation method performed by the memory device are disclosed. The memory device includes a plurality of memories, and one or more memory banks including an in-memory operator configured to encode data stored in at least one of the plurality of memories, perform an assigned operation based on the encoded data, and decode the encoded data on which the operation is performed, and a memory controller configured to control the one or more memory banks.

### CROSS-REFERENCE TO RELATED APPLICATIONS

This application claims the benefit under 35 USC § 119(a) of Korean Patent Application No. 10-2022-0023219, filed on Feb. 22, 2022, at the Korean Intellectual Property Office, the entire disclosure of which is incorporated herein by reference for all purposes.

### BACKGROUND

### 1. Field

The following description relates to a memory device and operation technology performed by the memory device.

### 2. Description of Related Art

Applications for graphics algorithms processing, neural network processing, big data processing, and the like involve compute-intensive operations and require a computing system, with large-scale memory, capable of performing large-scale operations. When the computing system processes the applications, a large amount of data is transmitted and received between a memory device and a processor in a computing device. In recent years, research on technical solutions to effectively process a large amount of data, such as distributed processing and parallel processing, has been actively conducted.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a memory device includes a memory bank including a plurality of memories and an in-memory operator configured to encode data stored in at least one of the plurality of memories, perform an assigned operation based on the encoded data, and decode the encoded data on which the operation is performed, and a memory controller configured to control the memory bank.

The in-memory operator may be further configured to, in response to reception of a transmission request from another device for the encoded data on which the operation is performed, transmit, to the other device, decoded data obtained by decoding the encoded data on which the operation is performed.

The in-memory operator may be further configured to, in encoding the stored data, generate metadata related to the encoding. The metadata may include any one or any combination of any two or more of size information of the encoded data, encoding type information, and matrix coordinate information corresponding to the encoded data.

The in-memory operator may be further configured to, in decoding the encoded data on which the operation is performed, perform the decoding using the metadata.

Whether to generate the metadata may depend on an encoding scheme or a type of an operation to be performed on the encoded data.

The in-memory operator may be further configured to, in response to reception of a transmission request from another device for the encoded data on which the operation is performed, transmit, to the other device, the encoded data on which the operation is performed and the metadata.

The in-memory operator may be further configured to generate encoded data by removing values corresponding to a reference value from values comprised in the stored data.

The in-memory operator may be further configured to, in response to completion of the operation, store result data of the operation in the at least one of the plurality of memories.

The memory device may further include another memory bank including another in-memory operator. The in-memory operator and the other in-memory operator may be configured to generate encoded data by compressing the stored data in parallel in a buffer of the memory bank.

The in-memory operator may be further configured to encode the stored data using either one or both of sparsification compression and quantization compression.

The in-memory operator may be further configured to generate encoded data having a smaller size than a size of the stored data by encoding the stored data.

In another general aspect, an operation method includes encoding, by an in-memory operator comprised in a memory bank, data stored in the memory bank; performing, by the in-memory operator, an assigned operation based on the encoded data; and decoding, by the in-memory operator, the encoded data on which the operation is performed.

The decoding of the encoded data on which the operation is performed may include, in response to reception of a transmission request from another device for the encoded data on which the operation is performed: decoding the encoded data on which the operation is performed; and transmitting the decoded data to the other device.

The encoding of the data stored in the memory bank may include, in encoding the stored data, generating metadata related to the encoding. The metadata may include any one or any combination of any two or more of size information of the encoded data, encoding type information, and matrix coordinate information corresponding to the encoded data.

The operation method may further include, in response to reception of a transmission request, from another device, for the encoded data on which the operation is performed: transmitting, to the other device, the encoded data on which the operation is performed and the metadata.

The encoding of the data stored in the memory bank may include generating encoded data by removing values corresponding to a reference value from values comprised in the stored data.

The encoding of the data stored in the memory bank may include encoding the stored data using either one or both of sparsification compression and quantization compression.

The operation method may further include storing the encoded data on which the operation is performed in a memory of the memory bank.

The encoding of the data stored in the memory bank may include generating encoded data having a smaller size than a size of the stored data by encoding the stored data.

A non-transitory computer-readable storage medium may store instructions that, when executed by a processor, cause the processor to perform any of the operations herein.

Other features and aspects will be apparent from the following detailed description, the drawings, and the claims.

### BRIEF DESCRIPTION OF THE DRAWINGS

FIG. 1 illustrates an example of a memory device, according to one or more embodiments.

FIG. 2 illustrates an example of operations of an operation method performed by an in-memory operator included in a memory bank, according to one or more embodiments.

FIG. 3 illustrates an example of encoding data stored in a memory, according to one or more embodiments.

FIGS. 4A-4C illustrate another example of encoding data stored in a memory, according to one or more embodiments.

FIG. 5 illustrates an example of processing performed by an in-memory operator, according to one or more embodiments.

FIG. 6 illustrates an example of a computing device, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

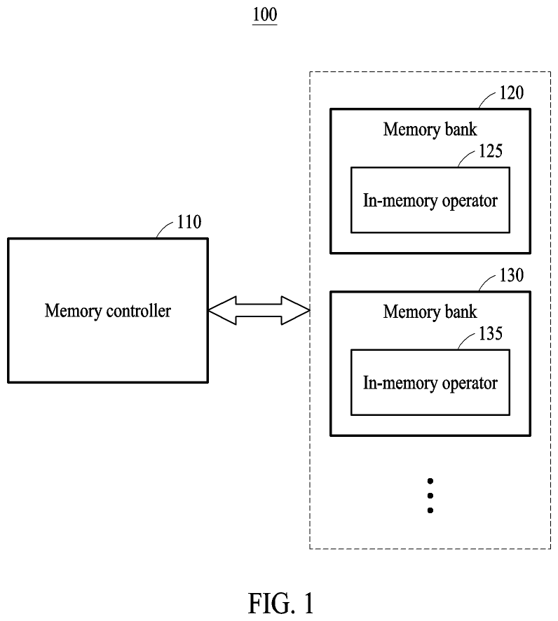

FIG. 1 illustrates an example of a memory device, according to one or more embodiments.

Referring to FIG. 1, a memory device 100, which performs memory-related processing, may be included in a computing device (e.g., a computing device 600 of FIG. 6) to perform operations. The memory device 100 may be implemented as a memory chip or a memory module. Implementation forms may vary and are not limited thereto.

The memory device 100 may include one or more memory banks 120 and 130 and a memory controller 110. The memory banks 120 and 130 may be a divided area inside the memory device 100 that sequentially operates to continuously transmit data to a processing unit (e.g., a central processing unit (CPU)), a digital signal processor (DSP), a graphics processing unit (GPU), or an application processor (AP). The memory banks 120 and 130 may be used to speed up data transmission between the memory device 100 and a processing device and may be managed by the memory controller 110 in the computing device. One or more memory bank 120 and one or more memory bank 130 may be variably included in the memory device 100.

The memory banks 120 and 130 may each include a plurality of memories (or memory cells) and include in-memory operators 125 and 135, respectively. The plurality of memories may store data. The plurality of memories may include a dynamic random access memory (DRAM), such as a double data rate synchronous dynamic random access memory (DDR SDRAM), a low power double data rate (LPDDR) SDRAM, a graphics double data rate (GDDR) SDRAM, a rambus dynamic random access memory (RDRAM), and the like, and include a non-volatile memory, such as a flash memory, a magnetic RAM (MRAM), a ferroelectric RAM (FeRAM), a phase change RAM (PRAM), a resistive RAM (ReRAM), and the like. The in-memory operators 125 and 135 may process or operate on (i.e., compute) data stored in a memory in various ways. The memory banks 120 and 130 may compress memory data using the in-memory operators 125 and 135 in the memory banks 120 and 130, and perform an operation (i.e., computation) on the compressed memory data in the memory banks 120 and 130.

The in-memory operators 125 and 135 may be implemented as processing elements for performing operation processing. The in-memory operators 125 and 135 may be an Arithmetic Logic Unit (ALU) or Multiply-Accumulate (MAC). Alternatively, the in-memory operators 125 and 135 may be implemented as an array of a plurality of logic gates, or a combination of an array of logic gates and a buffer for temporarily storing data.

The in-memory operators 125 and 135 may perform an operation, for example, data invert, data shift, data swap, data compare, logical operations (e.g., AND, OR, XOR, etc.), mathematical operations (e.g., addition, subtraction, etc.), and deep learning operations (e.g., activation, normalization, etc.). A type of an operation that the in-memory operators 125 and 135 may perform is not limited thereto, and the in-memory operators 125 and 135 may perform various operations.

The in-memory operators 125 and 135 may encode data stored in one or more of the plurality of memories, perform an assigned operation based on the encoded data, and decode the encoded data on which the operation is performed. The in-memory operators 125 and 135 may generate encoded data reduced in size compared to the data stored in the memory by encoding the data stored in the memory. The in-memory operators 125 and 135 may generate encoded data by compressing the data stored in the memory in parallel in a buffer of the memory banks 120 and 130. The in-memory operators 125 and 135 may encode the data stored in the memory using, for example, one or more of sparsification compression and quantization compression. Sparsification compression is a process of increasing the sparsity of data while removing values with low significance. When encoding the data stored in the memory using sparsification compression, the in-memory operators 125 and 135 may generate encoded data by removing values corresponding to a reference value (e.g., 0) from values included in the data stored in the memory. In addition, the in-memory operators 125 and 135 may generate encoded data by removing values less than or equal to the reference value from the values included in the data stored in the memory. When using quantization compression, the in-memory operators 125 and 135 may generate encoded data by performing quantization with respect to the values included in the data stored in the memory.

In encoding the data stored in the memory, the in-memory operators 125 and 135 may generate metadata related to the encoding. The metadata may include, for example, any one or any combination of size information of encoded data, encoding type information, and matrix coordinate information corresponding to the encoded data. Whether to generate the metadata may depend on an encoding scheme or a type of operation to be performed on the encoded data. For example, the in-memory operators 125 and 135 may not generate the metadata when the operation is a linear type operation, such as activation, normalization, optimization, and matrix multiplication (matmul, dot) of deep learning, or a basic linear algebra subprograms (BLAS) operation that performs a general linear algebra operation, such as vector addition, scalar multiplication, vector inner product (dot product), linear combination, and matrix multiplication, and may generate the metadata when the operation is a vector type or an embedding type operation.

The in-memory operators 125 and 135 may perform an assigned operation based on the encoded data and store result data of the operation in the memory in response to the completion of the operation on the encoded data. A process of encoding the data stored in the memory and a process of performing an operation based on the encoded data may be performed concurrently in parallel by another operation device (e.g., a GPU, a neural processing unit (NPU)) and the in-memory operators 125 and 135.

In response to the reception of a transmission request from another operation device (e.g., a CPU and a GPU), for the encoded data on which the operation is performed, the in-memory operators 125 and 135 may transmit to the other device, the encoded data on which the operation is performed and metadata (if metadata corresponding to the encoded data exists). In addition, the in-memory operators 125 and 135 may transmit decoded data obtained by decoding the encoded data on which the operation is performed to the other operation device. In response to the generation of metadata during the process of encoding the data, the in-memory operators 125 and 135 may perform decoding using the metadata when decoding the encoded data on which the operation is performed.

As described above, the memory device 100 may use the in-memory operators 125 and 135 in the memory banks 120 and 130 to perform encoding, operations, and decoding of memory data, thereby reducing memory usage and the number of operations. Furthermore, since the in-memory operators 125 and 135 compress the memory data and even perform operations after the compression, memory efficiency and operation efficiency may be improved.

The memory controller 110 may control the overall operation of the memory device 100. The memory controller 110 may control the memory banks 120 and 130 by providing various signals to the memory banks 120 and 130. For example, the memory controller 110 may control a memory access operation, such as read or write, for the memory banks 120 and 130. The memory controller 110 may write data to the memory banks 120 and 130 or read the data stored in the memory banks 120 and 130, based on instructions for memory access and a memory address. The memory controller 110 may also control operations of the in-memory operators 125 and 135 by transmitting a signal for instructing the in-memory operators 125 and 135 included in the memory banks 120 and 130 to perform an operation. In addition, the memory controller 110 may provide a clock signal for synchronization to the memory banks 120 and 130.

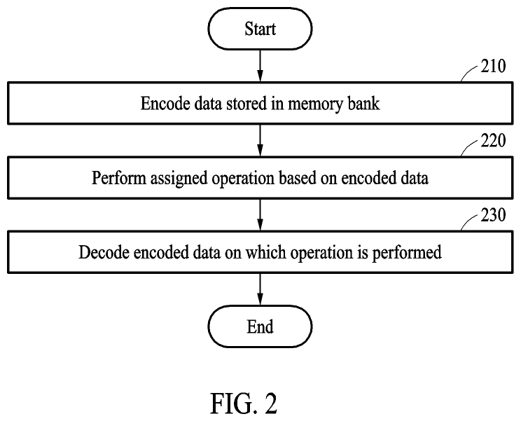

FIG. 2 illustrates an example of operations of an operation method performed by an in-memory operator included in a memory bank, according to one or more embodiments.

Referring to FIG. 2, in operation 210, the in-memory operator (e.g., the in-memory operator 125 or 135 of FIG. 1) may encode data (i.e., memory data) stored in a memory bank (e.g., the memory bank 120 or 130 of FIG. 1). Encoding may include coding and compressing data to reduce an amount of data. The in-memory operator may generate encoded data by compressing data stored in a memory in parallel in a buffer of the memory bank. The in-memory operator may store encoded data on which an operation is performed in a memory of the memory bank.

The in-memory operator may encode data stored in the memory using, for example, one or more of sparsification compression and quantization compression. When encoding the data stored in the memory using sparsification compression, the in-memory operator may generate encoded data by removing (i.e., zeroing out) values corresponding to a reference value from values included in the data stored in the memory. In addition, the in-memory operator may generate encoded data by removing values less than or equal to the reference value from the values included in the data stored in the memory. When using quantization compression, the in-memory operator may generate encoded data by performing quantization with respect to the values included in the data stored in the memory. As such, the memory device may compress memory data using the in-memory operator in the memory bank. The in-memory operator may remove memory data that is not required for an operation.

In an example, in encoding data, the in-memory operator may generate metadata related to the encoding. The generated metadata may include, for example, any one or any combination of size information of encoded data, information encoding type, and matrix coordinate information corresponding to the encoded data. The in-memory operator may generate and store metadata, if necessary. Whether to generate the metadata may depend on an encoding scheme applied to memory data or a type of an operation to be performed on the encoded data. The metadata may store, for example, information, such as size information or index information (e.g., data coordinate information if a bitmap encoding scheme is used), of compressed data.

In operation 220, the in-memory operator may perform an assigned operation based on the encoded data. In response to the completion of the operation on the encoded data, the in-memory operator may store the result data of the operation being in an encoded state in memory. If it is possible to perform additional encoding according to a result of the operation, the in-memory operator may additionally perform encoding on the result data of the corresponding operation. The in-memory operator may perform an operation on two or more pieces of encoded data using metadata. Performing the operation on the data being in an encoded state may reduce the number of required operations. In response to the reception of a transmission request, from another operation device, for the encoded data on which the operation is performed, the in-memory operator may transmit, to the other operation device, the encoded data on which the operation is performed and the metadata (if metadata corresponding to the encoded data exists).

In operation 230, the in-memory operator may decode the encoded data on which the operation is performed. For example, the in-memory operator may decompress the encoded data on which the operation is performed. Decoding may include restoring a data form that is transformed as a result of encoding to its original data form. In response to the generation of metadata during the process of encoding the data, the in-memory operator may perform decoding using the metadata when decoding the encoded data on which the operation is performed. In response to the reception of a transmission request, from another operation device, for the encoded data on which the operation is performed, the in-memory operator may decode the encoded data and transmit the decoded data to the other operation device.

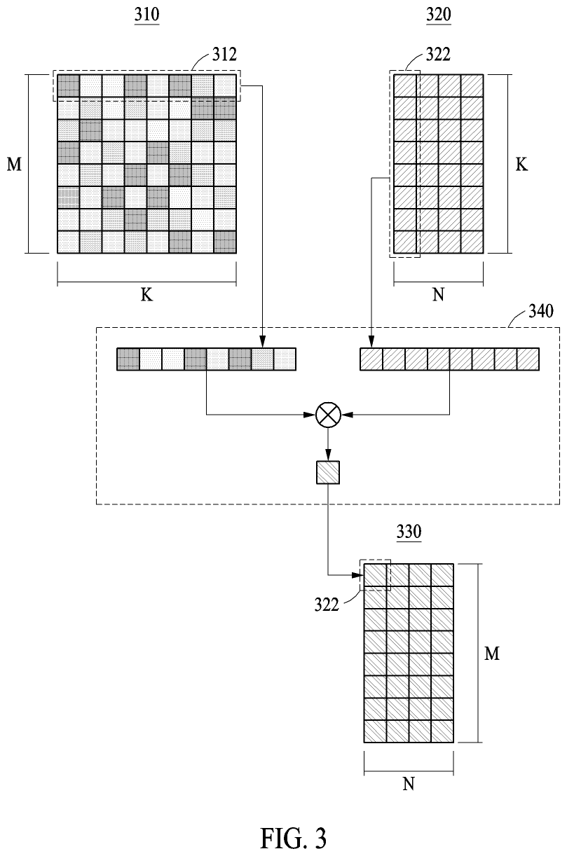

FIG. 3 illustrates an example of encoding data stored in a memory, according to one or more embodiments.

Referring to FIG. 3, an in-memory operator (e.g., the in-memory operator 125 or 135 of FIG. 1) may encode data stored in a memory of a memory bank using sparsification compression (or a sparse operation). Assuming the data stored in the memory is a matrix 310 with a size of M×K, the in-memory operator may apply a sparsified matrix 320 with a size of K×N to the matrix 310 to generate an encoded matrix 330 with a size reduced to M×N. The encoding process may include a process of performing a matrix multiplication between row elements 312 of the matrix 310 and column elements 322 of the sparsified matrix 320 to determine 340 an element 322 of the encoded matrix 330, and this process may be sequentially performed with respect to all elements of the matrix 310. Through this process, the encoded matrix 330 with higher density, which is a compressed form of the matrix 310, may be generated. The in-memory operator may decode the encoded matrix 330 by multiplying the encoded matrix 330 by an inverse matrix of the sparsified matrix 320.

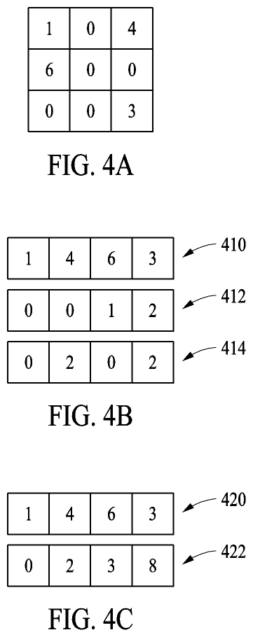

FIGS. 4A-4C illustrate another example of encoding data stored in a memory, according to one or more embodiments.

An in-memory operator (e.g., the in-memory operator 125 or 135 of FIG. 1) may encode data stored in a memory of a memory bank using sparsification compression different from the sparsification compression illustrated FIG. 3.

FIG. 4A illustrates an example of memory data in a matrix form stored in the memory of the memory bank.

The in-memory operator may remove a reference value, such as values corresponding to “0”, and extract values other than “0” from memory data. Reference numeral 410 in FIG. 4B corresponds to encoded data which is data obtained by removing “0” from the memory data of FIG. 4A and extracting values other than “0” (1, 4, 6, 3). Reference numeral 412 represents y-coordinate values (0, 0, 1, 2) respectively corresponding to the values (1, 4, 6, 3) of the encoded data, and reference numeral 414 shows x-coordinate values (0, 2, 0, 2) respectively corresponding to the values (1, 4, 6, 3) of the encoded data. A coordinate value of “1” in the memory data of FIG. 4A corresponds to (0, 0), a coordinate value of “4” corresponds to (2, 0), a coordinate value of “6” corresponds to (0, 1), and a coordinate value of “3” corresponds to (2, 2). The in-memory operator may generate and store matrix coordinate information of the reference numeral 412 and the reference numeral 414 as metadata. The metadata may be used when decoding the encoded data 410 and transmitted to another device along with the encoded data 410.

FIG. 4C illustrates matrix coordinate information in a form different from that illustrated in FIG. 4B. Reference numeral 420 represents encoded data obtained by removing values corresponding to “0” and extracting values other than “0” from the memory data of FIG. 4A, and reference numeral 422 represents matrix position values corresponding to the encoded data 420. Matrix position values respectively corresponding to the values (1, 4, 6, 3) of the encoded data is (0, 2, 3, 8). For example, a matrix position value of 0 indicates a value positioned at a first element in the matrix of FIG. 4A, and a matrix position value of 2 indicates a value positioned at a third element in the matrix of FIG. 4A. The in-memory operator may generate and store the matrix position values of the reference numeral 422 as metadata.

The in-memory operator may generate metadata according to an encoding scheme as described above, but if an operation that does not require metadata is scheduled to be performed, metadata may not be generated during a process of encoding the memory data.

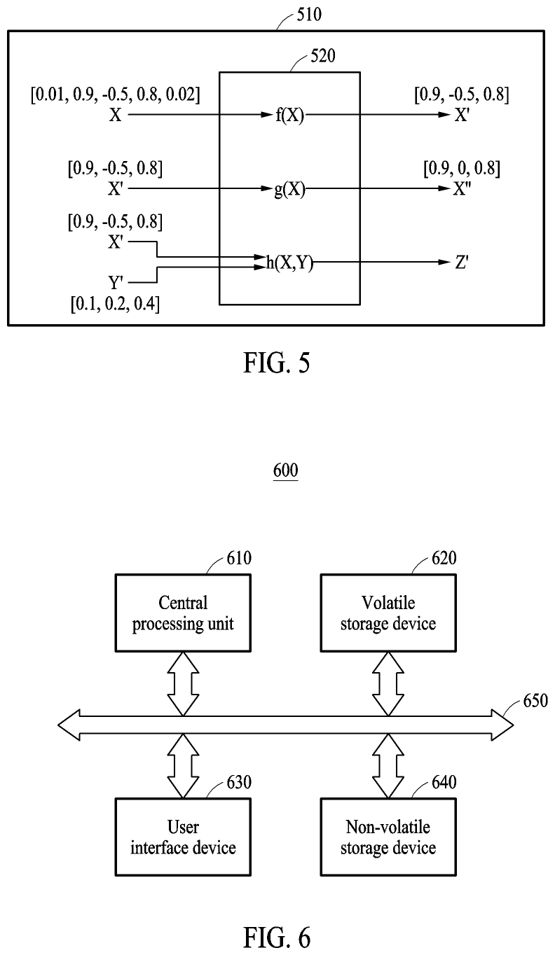

FIG. 5 illustrates an example of processing performed by an in-memory operator, according to one or more embodiments.

Referring to FIG. 5, a memory bank 510 (e.g., the memory bank 120 or 130 of FIG. 1) may include an in-memory operator 520 (e.g., the in-memory operator 125 or 135 of FIG. 1) that performs data decoding and an operation in the memory bank. In response to performing sparsification compression, the in-memory operator 520 may convert, according to an encoding algorithm f(x), values close to “0” (or values less than or equal to a reference value) into “0” in data X stored in a memory and generate encoded data X′ by removing/zeroing out values of “0” (removing all values identified as being “0” in a matrix) that are not required for an operation.

The in-memory operator 520 may generate and store necessary metadata according to an operation to be performed. The in-memory operator 520 may not generate metadata when an operation to be performed does not require metadata. For example, supposing recomputation is performed after activation checkpointing is used for effective memory usage in neural network training, if a linear operation is performed as a backward operation of a neural network to acquire a gradient by performing recomputation, metadata is not required for the operation. For a matrix element-wise operation or a scalar operation, metadata is not required for the operations because the operations are performed on all memory data, and thus given operations may be performed immediately. For example, assuming the in-memory operator 520 is to perform a linear operation, the in-memory operator 520 may perform an operation on the encoded data X′ according to a given operation algorithm g(x) without using metadata to determine encoded data X″ on which the operation is performed. The in-memory operator 520 may perform an operation on memory data being in an encoded state.

When an operation is performed on two or more pieces of data, for example, an operation, such as a vector operation, a low-rank approximation, a matrix multiplication, and an embedding operation, is performed based on information on each position of data, metadata of the encoded memory data is required for the operation. For example, assuming an operation algorithm h(X, Y) is a vector operation (e.g., dot product), a vector operation for X′ and Y′ may be performed based on index information of a memory indicating information on each position of the data. The metadata may be removed without being stored, in response to an operation result being a scalar, and the metadata may be stored along with operation result data, in response to the operation result being a vector or a matrix.

When another operation device (e.g., a CPU and a GPU) requests encoded data, stored in the memory bank 510, on which an operation is performed by the in-memory operator 520, the in-memory operator 520 may transmit the encoded data to the other operation device while decoding the encoded data. When the encoded data is transmitted to the other operation device, processes after the encoded data on which the operation is performed is read in the memory bank 510 may be performed when the encoded data is transmitted via a data bus. In this case, the encoded data on which the operation is performed may be transmitted via the data bus while being decoded.

FIG. 6 illustrates an example of a computing device, according to one or more embodiments.

Referring to FIG. 6, a computing device 600 may be, for example, a mobile device, a desktop computer, or a server device. The computing device 600 may include a CPU 610, a volatile storage device 620, a user interface device 630, and a non-volatile storage device 640. At least some of the components may be coupled mutually and communicate signals (e.g., instructions or data) therebetween via an inter-peripheral communication interface 650 (e.g., a bus, general purpose input and output (GPIO), a serial peripheral interface (SPI), a mobile industry processor interface (MIPI)).

The CPU 610 may control overall operations of the computing device 600 and execute functions and instructions to be executed within the computing device 600. The CPU 610 may include a main processor (e.g., the CPU 610 or an AP) or an auxiliary processor (e.g., a GPU and an NPU) that is operable independently of, or in conjunction with the main processor.

The volatile storage device 620 may include a volatile storage device such as RAM. The volatile storage device 620 may include a memory device described herein (e.g., the memory device 100 of FIG. 1). The volatile storage device 620 may internally perform an operation, encoding, and decoding of memory data via a memory bank, including an in-memory operator.

The user interface device 630 is a device for performing interaction between a person (a user) and the computing device 600 (or a computer program running on the computing device 600), and may include physical hardware and logical software. For example, the user interface device 630 may include an input device, such as a keyboard, a mouse, a touch pad, and a microphone, capable of transmitting a user input to the computing device 600 and an output device, such as a liquid display or a light emitting diode (LED)/organic light emitting diode (OLED) display, a micro LED, a touch screen, a speaker, and a vibration generating device, capable of providing an output to the user.

The non-volatile storage device 640 may include a non-volatile memory, such as a read-only memory (ROM) and a flash memory, and a large-capacity storage device, such as a solid-state drive and a hard disk drive.

As a non-exhaustive example only, a computing device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

The memory device 100, memory controller 110, and computing device 600 in FIGS. 1-6 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A memory device comprising:
a memory bank comprising a plurality of memories and an in-memory operator configured to encode data stored in at least one of the plurality of memories, perform an assigned operation based on the encoded data, and decode the encoded data on which the operation is performed; and
a memory controller configured to control the memory bank.

2. The memory device of claim 1, wherein the in-memory operator is further configured to, in response to reception of a transmission request from another device for the encoded data on which the operation is performed, transmit, to the other device, decoded data obtained by decoding the encoded data on which the operation is performed.

3. The memory device of claim 1, wherein
the in-memory operator is further configured to, in encoding the stored data, generate metadata related to the encoding, and
the metadata comprises any one or any combination of any two or more of size information of the encoded data, encoding type information, and matrix coordinate information corresponding to the encoded data.

4. The memory device of claim 3, wherein the in-memory operator is further configured to, in decoding the encoded data on which the operation is performed, perform the decoding using the metadata.

5. The memory device of claim 3, wherein whether to generate the metadata depends on an encoding scheme or a type of an operation to be performed on the encoded data.

6. The memory device of claim 3, wherein the in-memory operator is further configured to, in response to reception of a transmission request from another device for the encoded data on which the operation is performed, transmit, to the other device, the encoded data on which the operation is performed and the metadata.

7. The memory device of claim 1, wherein the in-memory operator is further configured to generate encoded data by removing values corresponding to a reference value from values comprised in the stored data.

8. The memory device of claim 1, wherein the in-memory operator is further configured to, in response to completion of the operation, store result data of the operation in the at least one of the plurality of memories.

9. The memory device of claim 1, further comprising another memory bank comprising another in-memory operator,
wherein the in-memory operator and the other in-memory operator are configured to generate encoded data by compressing the stored data in parallel in a buffer of the memory bank.

10. The memory device of claim 1, wherein the in-memory operator is further configured to encode the stored data using either one or both of sparsification compression and quantization compression.

11. The memory device of claim 1, wherein the in-memory operator is further configured to generate encoded data having a smaller size than a size of the stored data by encoding the stored data.

12. An operation method, comprising:
encoding, by an in-memory operator comprised in a memory bank, data stored in the memory bank;
performing, by the in-memory operator, an assigned operation based on the encoded data; and
decoding, by the in-memory operator, the encoded data on which the operation is performed.

13. The operation method of claim 12, wherein the decoding of the encoded data on which the operation is performed comprises, in response to reception of a transmission request from another device for the encoded data on which the operation is performed:
decoding the encoded data on which the operation is performed; and
transmitting the decoded data to the other device.

14. The operation method of claim 12, wherein
the encoding of the data stored in the memory bank comprises, in encoding the stored data, generating metadata related to the encoding, and
the metadata comprises any one or any combination of any two or more of size information of the encoded data, encoding type information, and matrix coordinate information corresponding to the encoded data.

15. The operation method of claim 14, further comprising, in response to reception of a transmission request, from another device, for the encoded data on which the operation is performed:
transmitting, to the other device, the encoded data on which the operation is performed and the metadata.

16. The operation method of claim 12, wherein the encoding of the data stored in the memory bank comprises generating encoded data by removing values corresponding to a reference value from values comprised in the stored data.

17. The operation method of claim 12, wherein the encoding of the data stored in the memory bank comprises encoding the stored data using either one or both of sparsification compression and quantization compression.

18. The operation method of claim 12, further comprising:
storing the encoded data on which the operation is performed in a memory of the memory bank.

19. The operation method of claim 12, wherein the encoding of the data stored in the memory bank comprises generating encoded data having a smaller size than a size of the stored data by encoding the stored data.

20. A non-transitory computer-readable storage medium storing instructions that, when executed by a processor, cause the processor to perform the operation method of claim 12.
